(19) United States
(12) Patent Application Publication
(10) Pub. No.: US 2022/0217948 A1
(43) Pub. Date: Jul. 14, 2022

(54) Dog Leash Control Sleeve Device

(71) Applicant: Darren Genson, Millersville, MD (US)

(72) Inventor: Darren Genson, Millersville, MD (US)

(21) Appl. No.: 17/569,740

(22) Filed: Jan. 6, 2022

Related U.S. Application Data
(60) Provisional application No. 63/135,640, filed on Jan. 10, 2021.

(51) Int. Cl. A01K 27/00

(52) U.S. Cl. CPC A01K 27/003

(57) ABSTRACT

The present invention relates generally to the field of dog control devices. More specifically, the present invention relates to a dog leash control sleeve device that is primarily comprised of a generally cylindrical, rigid body in the form of a central shaft. The shaft is further comprised of a first end with a handle and a second end with a handle. Each end is further comprised of a continuous opening that allows a dog leash to be inserted through each handle and through the central shaft. Therefore, the device can be attached around a dog leash while it is attached to a dog or other animal. While attached around a leash, the handles of the device can be grabbed to provide extra control over the dog or animal attached to the leash. The device may also be comprised of a wrist strap and a post that a leash can be wrapped around for additional stability and security to a user.

### CROSS-REFERENCE TO RELATED APPLICATION

The present application claims priority to, and the benefit of, U.S. Provisional Application No. 63/135,640 which was filed on Jan. 10, 2021 and is incorporated herein by reference in its entirety.

### FIELD OF THE INVENTION

The present invention relates generally to the field of dog or pet control devices. More specifically, the present invention relates to a dog leash control sleeve device that is primarily comprised of a generally cylindrical, rigid body in the form of a central shaft. The shaft is further comprised of a first end with a handle and a second end with a handle. Each end is further comprised of a continuous opening that allows a dog leash to be inserted through each handle and through the central shaft. Therefore, the device can be attached around a dog leash while it is attached to a dog or other animal. While attached around a leash, the handles of the device can be grabbed to provide extra control over the dog or animal attached to the leash. The device may also be comprised of a wrist strap and a post that a leash can be wrapped around for additional stability and security to a user. Accordingly, the present disclosure makes specific reference thereto. Nonetheless, it is to be appreciated that aspects of the present invention are also equally applicable to other like applications, devices and methods of manufacture.

### BACKGROUND

Fear, stress, and anxiety can make an animal difficult and dangerous to handle, especially while said animal is on a leash. All these conditions can further increase an animal's potential to act out or redirect aggressively toward a handler, other animals or even other people. Furthermore, an anxious handler can also inadvertently trigger unwanted behavior from an animal. For example, a dog on a leash may lunge or charge on the leash, and the handler might not be able to maintain a safe distance between the dog and other handlers, animals or people. In addition, a dog may be able to physically overpower its handler such that the handler cannot control the dog using the leash. Loss of the ability to control a dog using its leash further increase the risk for the dog to lunge, charge and potentially bite and seriously injure other handlers, animals and people.

Therefore, there exists a long-felt need in the art for a device that allows a user to better control a dog. There also exists a long-felt need in the art for a dog leash control sleeve device that allows a user to better control a dog on a leash. In addition, there exists a long-felt need in the art for a dog leash control sleeve device that allows a user to better control a dog on a leash, wherein the device reduces the possibility of the dog attacking the handler, other handlers, animals or people.

The subject matter disclosed and claimed herein, in one embodiment thereof, comprises a dog leash control sleeve device. The device is primarily comprised of a generally cylindrical, rigid body which has a central shaft. The shaft is further comprised of a first end with a handle and a second end with a handle. Each end is further comprised of a continuous opening that allows a dog leash to be inserted through each handle and through the central shaft. Therefore, the device can be attached around a dog leash while it is attached to a dog or other animal. While attached around a leash, the handles of the device can be grabbed to provide extra control over the dog or animal attached to the leash. The device may also be comprised of a wrist strap and a post that a leash can be wrapped around for additional stability and security to a user.

In this manner, the dog leash control sleeve device of the present invention accomplishes all of the forgoing objectives and allows a user to better control a dog, specifically when a dog is on a leash. Further, the device reduces the possibility of the dog attacking the handler, other handlers, animals or people. Further, the rigid material of the device creates physical separation between a handler and a dog, such that the dog cannot bite the handler.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dog leash control sleeve device. The device is primarily comprised of a generally cylindrical body in the form of a central shaft. The shaft further has a first end with a handle and a second end with a handle. In the preferred embodiment, the body is manufactured from a durable, rigid plastic material. Any surface of the body may have a plurality of indicia and may be any color known in the art.

The shaft is hollow and comprised of a first end and a second end. The first end and second end both have a continuous opening and a handle. In the preferred embodiment, the handle is manufactured from a rubber material and is textured to promote grip. To use the device, a dog leash can be fed through both continuous openings and the central shaft, such that the device surrounds the dog leash. When a user requires better control of the dog, they can simply retain the leash in one hand and grab either handle with the other hand to better control the leash and therefore control the dog.

Because the device is rigid, it creates physical distance/space between the dog and user when the device is around a leash. Therefore, a dog cannot turn and bite the user because of the fixed distance between the dog and user the device creates. In one embodiment, one or both handles may also be comprised of a post that a user can further wrap a leash around for better control. In addition, one or both handles may be comprised of a wrist strap that can be worn on the wrist of the user in order to further secure the device to the user.

Accordingly, the dog leash control sleeve device of the present invention is particularly advantageous as it allows a user to better control a dog on a leash. In doing so, the device reduces the possibility of the dog attacking the handler, other handlers, animals or people. Further, the rigid material of the device creates physical separation between a handler and a dog such that the dog cannot bite the handler. In this manner, the dog leash control sleeve device overcomes the limitations of existing dog control devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of multiple dog leash control sleeve devices of the present invention while attached around a dog leash in accordance with the disclosed architecture;

FIG. 2 illustrates an enhanced perspective view of one potential embodiment of a dog leash control sleeve device of the present invention in accordance with the disclosed architecture; and

FIG. 3 illustrates a perspective view of one potential embodiment of a dog leash control sleeve device of the present invention while attached around and being used to control a dog leash that is attached to a dog in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that allows a user to better control a dog. There also exists a long-felt need in the art for a dog leash control sleeve device that allows a user to better control a dog on a leash. In addition, there exists a long-felt need in the art for a dog leash control sleeve device that allows a user to better control a dog on a leash, wherein the device reduces the possibility of the dog attacking the handler, other handlers, animals or people.

The present invention, in one exemplary embodiment, is comprised of a dog leash control sleeve device primarily comprised of a generally cylindrical body further comprised of a first end with a handle, a central shaft and a second end with a handle. The body may be manufactured in the preferred embodiment from a durable, rigid plastic material. Any surface of the body may have a plurality of indicia and may be any color known in the art.

The body is further hollow and comprised of a first end and a second end, wherein both the first end and second end both have a continuous opening and a handle. In the preferred embodiment, the handle is manufactured from a rubber material and is textured to promote grip. A central shaft connects each handle, wherein each handle is fixedly attached to the shaft. To use the device, a dog leash can be fed through both continuous openings and the central shaft such that the device surrounds the dog leash. When a user requires better control of the dog, he or she can simply retain the leash in one hand and grab either handle with the other hand to better control the leash and therefore control the dog.

Due to the rigid nature of the device, it creates physical distance/space between the dog and user when the device is around a leash. As a result, a dog cannot turn and bite the user because of the fixed distance between the dog and the user the device creates. In one embodiment, one or both handles may also be comprised of a post that a user can further wrap a leash around for better control. In addition, one or both handles may be comprised of a wrist strap that can be worn on the wrist of the user in order to further secure the device to the user.

Accordingly, the dog leash control sleeve device of the present invention is particularly advantageous as it allows a user to better control a dog on a leash. In doing so, the device reduces the possibility of the dog attacking the handler, other handlers, animals or people. Further, the rigid material of the device creates physical separation between a handler and a dog such that the dog cannot bite the handler. In this manner, the dog leash control sleeve device overcomes the limitations of existing dog control devices known in the art.

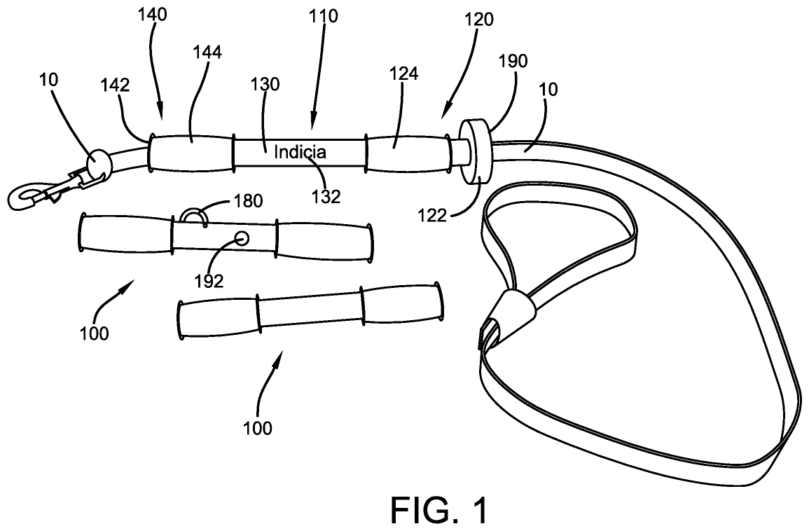

Referring initially to the drawings, FIG. 1 illustrates a perspective view of one potential embodiment of multiple dog leash control sleeve devices 100 of the present invention while attached around a dog leash 10 in accordance with the disclosed architecture. In the preferred embodiment, the device 100 is primarily comprised of a generally cylindrical body 110 further comprised of a central shaft 130 with a first end with a handle 124 and a second end 140 with a handle 144. In the preferred embodiment, the body 110 is manufactured from a durable, rigid, plastic material such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. Further, any surface of the body 110 may have a plurality of indicia 132 such as, but not limited to, patterns, logos, emblems, images, symbols, designs, letters, words, characters, animals, advertisements, brands, etc. The body 110 may also be any color known in the art and may be transparent, semi-transparent or opaque.

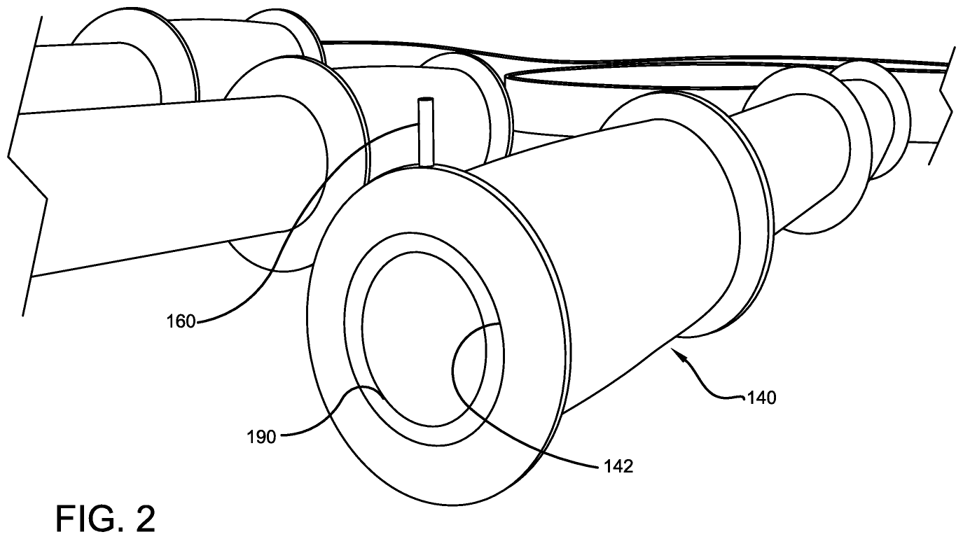

FIG. 2 illustrates an enhanced perspective view of one potential embodiment of a dog leash control sleeve device 100 of the present invention in accordance with the disclosed architecture. The shaft 130 is further hollow and comprised of a first end 120 and a second end 140. The first end 120 is comprised of a continuous opening 122 and a handle 124. In the preferred embodiment, the handle 124 is manufactured from a rubber material and is textured to promote grip. The second end 140 is comprised of a continuous opening 142 and a handle 144. In the preferred embodiment, the handle 144 is manufactured from a rubber material and is textured to promote grip. In one embodiment, the shaft 130 or either handle 124,144 may be additionally comprised of a quick-release clamp 180. The clamp 180 is preferably generally C-shaped and can receive and be secured around a loop-leash 10 such that the leash 10 can be held in an open position (i.e., a looped position) for quick capture or looping of a dog while maintaining a safer distance between the user's hand and the dog's head.

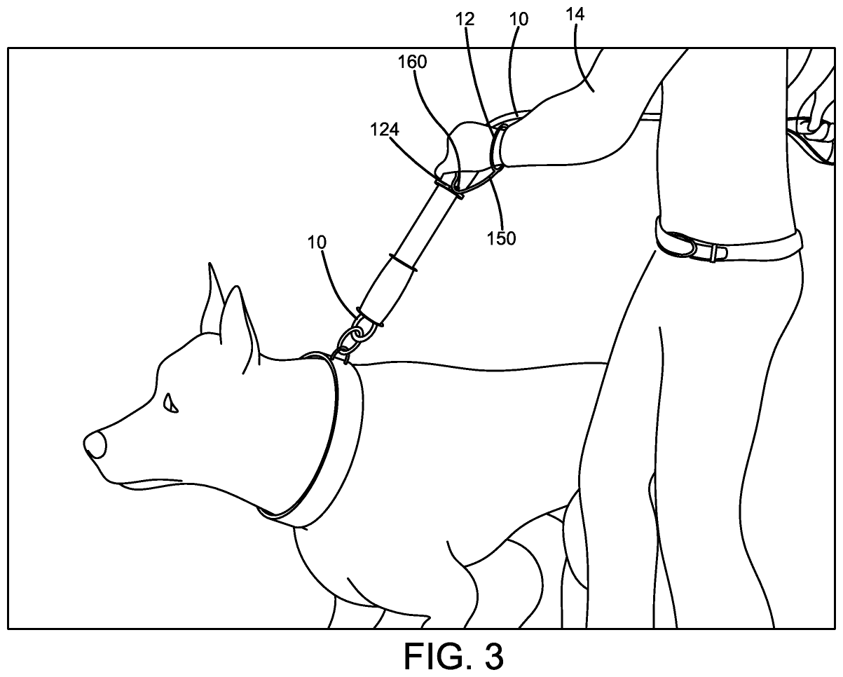

FIG. 3 illustrates a perspective view of one potential embodiment of a dog leash control sleeve device 100 of the present invention while attached around and being used to control a dog leash 10 that is attached to a dog in accordance with the disclosed architecture. To use the device 100, a dog leash 10 can be fed through both continuous openings 122,142 of the central shaft 130 such that the device 100 surrounds (i.e., encloses) the leash 10. In one embodiment, the interior of the shaft 130 or either opening 122,142 may be comprised of a locking mechanism 190. In one embodiment, the shaft 130 and/or handles 124,144 can be twisted or rotated such that the locking mechanism 190 tightens around a leash 10 that is within the shaft 130. In another embodiment, the locking mechanism 190 may be in the form of a hollow handle that a leash 10 passes through, wherein the handle can be pulled or turned to activate the locking mechanism 190. The mechanism 190 can further be activated by at least one control 192 on the shaft 130 and/or handles 124,144. In differing embodiments, the control 192 may be at least one lever or at least one button. In addition, the mechanism 190 may utilize a ratcheting locking mechanism in its operation.

When a user 14 requires better control of the dog, they can simply retain the leash 10 in one hand and grab a handle 124,144 with the other hand to better control the leash 10 and therefore control the dog. The leash 10 may further be comprised of a handle 11 that can be grabbed by a user and a clip 13 that can be removably attached to the collar of a dog.

It should also be noted that the device 100 creates physical distance/space between the dog and the user 14. Because of the rigid material of the device 100, a dog cannot turn and bite the user 14 because of the fixed distance between the dog and the user 14 the device 100 creates. In one embodiment, one or both handles 124, 144 may also be comprised of at least one post 160 that a user can further wrap a leash 10 around for better control. In one embodiment, the post 160 can further receive waste bags or other dog related accessories. In addition, one or both handles 124, 144 may be comprised of a wrist strap 150 that can be worn on the wrist 12 of the user 14 in order to further secure the device 100 to the user 14. The wrist strap 150 may further be comprised of at least one adjustable fastener 170 such as, but not limited to, a buckle, a snap-button, a zipper, a magnet, a sliding fastener, etc. that allows the strap 150 to be tightened or loosened around the wrist 12 of a user 14.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dog leash control sleeve device” and “device” are interchangeable and refer to the dog leash control sleeve device 100 of the present invention.

Notwithstanding the forgoing, the dog leash control sleeve device 100 of the present invention and its various components can be of any suitable size and configuration as is known in the art without affecting the overall concept of the invention, provided that they accomplish the above-stated objectives. One of ordinary skill in the art will appreciate that the size, configuration and material of the dog leash control sleeve device 100 as shown in the FIGS. are for illustrative purposes only, and that many other sizes and shapes of the dog leash control sleeve device 100 are well within the scope of the present disclosure. Although the dimensions of the dog leash control sleeve device 100 are important design parameters for user convenience, the dog leash control sleeve device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dog leash control sleeve device comprising:
a central shaft having a first end, a second end and a continuous opening extending between the first end and the second end; and
a handle positioned on each of the first and second ends of the central shaft.

2. The dog leash control sleeve device of claim 1, wherein the continuous opening is sized and configured to accommodate a dog leash extending therethrough.

3. The dog leash control sleeve device of claim 1, wherein the central shaft is manufactured from a rigid material.

4. The dog leash control sleeve device of claim 1, wherein each of the handle of the first end and the handle of the second end comprises a textured surface.

5. The dog leash control sleeve device of claim 1 further comprising a wrist strap.

6. A dog leash control system comprising:
a dog leash; and
a central shaft having a first end, a second end and a continuous opening extending between the first end and the second end;
a handle positioned on each of the first and second ends of the central shaft; and
a wrist strap.

7. The dog leash control system of claim 6, wherein the dog leash extends through the continuous opening.

8. The dog leash control system of claim 6, wherein the wrist strap comprises a fastener.

9. The dog leash control system of claim 8, wherein the fastener allows the wrist strap to tighten or loosen around a wrist of a user.

10. The dog leash control system of claim 8, wherein the fastener is a buckle, a snap-button, a zipper, a magnet or a sliding fastener.

11. The dog leash control system of claim 6, wherein the central shaft is manufactured from a rigid material.

12. The dog leash control system of claim 6, wherein each of the handle of the first end and the handle of the second end comprises a textured surface.

13. The dog leash control system of claim 12, wherein at least one of the handle of the first end or the handle of the second end is comprised of a post.

14. A pet leash control system comprising:
a leash comprised of a leash handle on a first end and a leash clip on a second end;
a central shaft having a first end, a second end and a continuous opening extending between the first end and the second end;
a handle positioned on at least one of the first and second ends of the central shaft; and
a wrist strap.

15. The pet leash control system of claim 14, wherein the leash extends through the continuous opening.

16. The pet leash control system of claim 14, wherein the wrist strap is further comprised of a fastener.

17. The pet leash control system of claim 16, wherein the fastener allows the wrist strap to tighten or loosen on a wrist of a user.

18. The pet leash control system of claim 17, wherein the fastener is a buckle, a snap-button, a zipper, a magnet or a sliding fastener.

19. The pet leash control system of claim 14, wherein the handle is comprised of a textured surface.

20. The pet leash control system of claim 19, wherein the handle comprises a post.
